(19) United States
(12) Patent Application Publication
(10) Pub. No.: US 2026/0235715 A1
(43) Pub. Date: Aug. 13, 2026

(54) USER EQUIPMENT LOCATION VERIFICATION IN NON-TERRESTRIAL NETWORKS

(71) Applicant: Apple Inc., Cupertino, CA (US)

(72) Inventors: Chunxuan Ye, San Diego, CA (US); Dawei Zhang, Saratoga, CA (US); Wei Zeng, Saratoga, CA (US); Hong He, San Jose, CA (US); Weidong Yang, San Diego, CA (US); Oghenekome Oteri, San Diego, CA (US)

(21) Appl. No.: 19/156,055

(22) PCT Filed: Jan. 16, 2024
(86) PCT No.: PCT/US2024/011688

§ 371 Date: Aug. 13, 2025

Related U.S. Application Data
(60) Provisional application No. 63/446,154, filed on Feb. 16, 2023.

(51) Int. Cl. G01S 5/02; H04L 1/1812

(52) U.S. Cl. CPC G01S 5/0249; G01S 5/02216; G01S 5/0236; H04L 1/1812

(57) ABSTRACT

A device such as a location management function (LMF) may receive assistance data including uplink (UL)-angle of arrival (AoA) information. In some examples, the UL-AoA information may be associated with one or more UL transmissions from a user equipment (UE) to a non-terrestrial network (NTN) device. The device may perform a positioning procedure using the UL-AoA information. In some examples, a UE may transmit, to an LMF, assistance data information including a number of satellites in view and satellite ephemeris data for one or more satellites of the number of satellites in view. In some examples, a UE may receive, from an NTN device, a downlink control information (DCI) message. The DCI message may include a physical uplink control channel (PUCCH) repetition number for Msg4 hybrid automatic repeat request (HARQ) acknowledgement (ACK).

### CROSS-REFERENCE TO RELATED APPLICATION

This Patent Cooperation Treaty patent application claims priority to U.S. Provisional Patent Application No. 63/446,154, filed Feb. 16, 2023, and titled “User Equipment Location Verification in Non-Terrestrial Networks,” the contents of which are incorporated herein by reference in its entirety.

### TECHNICAL FIELD

This application relates generally to wireless communication systems, including techniques for user equipment (UE) location verification in non-terrestrial networks (NTNs).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®)

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example non-terrestrial network (NTN) communication system including examples of a UE and one or more network devices in a 3GPP NR and NG-RAN based NTN.

FIG. 2 illustrates a first example of communication by a local management function (LMF).

FIG. 3 illustrates an example scenario in a 3GPP NR and NG-RAN based NTN.

FIG. 4 illustrates a second example of wireless communication by a UE.

FIG. 5 illustrates a third example of wireless communication by a UE.

FIG. 6 illustrates an example architecture of a wireless communication system, according to embodiments disclosed herein.

FIG. 7 illustrates a system for performing signaling between a wireless device, an NTN device and a network device, according to embodiments disclosed herein.

### DETAILED DESCRIPTION

Various embodiments are described with regard to a UE, an NTN device, a network device, and a location management function (LMF). However, reference to a UE, an NTN device, a network device, and an LMF is merely provided for illustrative purposes. The example embodiments may be utilized with any electronic component that may establish a connection to a network and is configured with the hardware, software, and/or firmware to exchange information and data with a network. Therefore, the UE, the NTN device, the network device, and the LMF as described herein is used to represent any appropriate electronic device.

In a 3GPP NR and NG-RAN based NTN, network verification of UE location may include multi-round trip time (multi-RTT) positioning and downlink (DL)-time difference of arrival (DL-TDOA) positioning techniques. In some cases, a single NTN device (e.g., satellite) may be in the view of a UE. In such cases, the satellite may be assumed to be moving over different geographical locations and may serve as a virtual gNB for these geographical locations. However, it is to be appreciated that various satellites/virtual gNBs may travel along a straight line, which may lead to a mirror-image ambiguity issue in determining a location of the UE that is in view of the satellite. In some embodiments, the satellite/virtual gNB and/or a gNB that is in communication with the satellite/virtual gNB UE, may report information to an LMF to address this mirror-image ambiguity issue.

For example, the gNB and/or the network may report uplink (UL)-angle of arrival (AoA) information to the LMF. That is, for example, the satellite/virtual gNB may detect an UL-AoA from the UE and may forward (e.g., via the network) the UL-AoA to the LMF. In some embodiments, the contents of UL-AoA information may be based at least in part on a global coordinate system or a local coordinate system. In cases when a local coordinate system is employed, the used reference coordinate system or reference coordination technique may also be reported from the satellite/virtual gNB and/or gNB to the LMF.

Additionally or alternatively, other information may be reported from the satellite/virtual gNB and/or gNB to the LMF, such as but not limit to assistance information and/or measurement results. For example, information provided to the LMF may include satellite ephemeris, satellite timing of a positioning reference signal (PRS) transmission and/or sounding reference signal (SRS) reception, a UE reported timing advance (TA) value, etc.

In some cases, multiple satellites may be in the view of a UE. In such cases, the UE may report information to the LMF to verify a location of the UE. That is, for example, the UE may report information corresponding to a number of satellites in view of the UE, ephemeris information of each satellite in view, whether the UE is in the orbit region of the satellites in view, and/or whether the multiple satellites have the same orbit.

NR coverage enhancement with respect to NTN are also described herein. For example, downlink control information (DCI) may include information for a UE in view of a satellite/virtual gNB. That is, for example, a DCI Format 1_0 with cyclic redundancy check (CRC) scrambled by a temporary cell-radio network identifier (TC-RNTI) may include a bit field to indicate a number of physical uplink control channel (PUCCH) repetitions for random access Msg4 hybrid automated repeat request (HARQ) acknowledgement (ACK) operation. In some cases, this bit field in the DCI format 1_0 exists only when operating in an NTN band. These PUCCH repetition techniques provide coverage enhancements to counter certain NTN characteristics including large propagation delay and satellite movement.

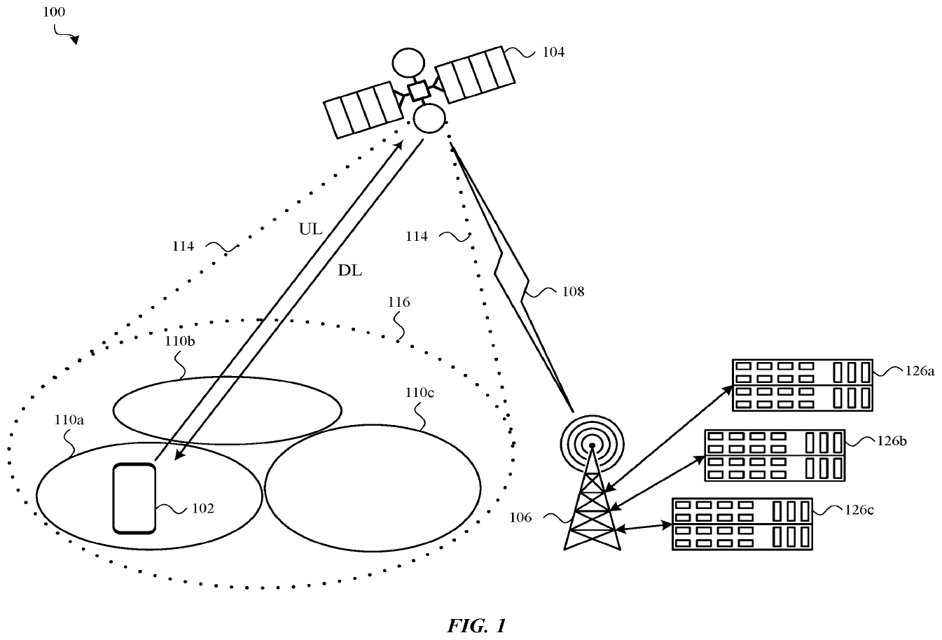

FIG. 1. illustrates an example of an NTN communication system 100, in accordance with some embodiments and various aspects of the present disclosure. NTN communication system 100 may be a 3GPP NR and NG-RAN based NTN as an example environment in which embodiments described herein may be practiced. In some embodiments, NTN communication system 100 may include a UE 102, an NTN device 104 (e.g., an NTN device on an NTN, such as but not limited to a satellite), a network device 106 (e.g., a network device of a RAN, such as but not limited to a base station or a gNB), a first CN 126a (e.g., including one or more first CN devices), a second CN 126b (e.g., including one or more second CN devices), and a third CN 126c (e.g., including one or more third CN devices).

The NTN device 104 may be a satellite, a high altitude international mobile telecommunication (IMT) base station (HIBS), a high-altitude platform-station (HAPS), etc. In some embodiments, the NTN device 104 may operate in accordance with a geostationary orbit (GEO), medium earth orbit (MEO) or a low earth orbit (LEO). In some embodiments, the NTN device 104 may operate in accordance with Ka-band GEO and non-GEO for DL in the 17.3-20.2 GHz frequency range and for UL in the 27.5-30.0 GHz frequency range. In some embodiments, the NTN device may operate in accordance with S-band for DL in the 2170-2200 MHZ frequency range and for UL in the 1980-2010 MHz frequency range.

A wide beam coverage area 114 may be provided by an NTN cell 116. The UE 102 may be within the coverage of the NTN cell 116 and may communicate with the NTN device 104 on a downlink (DL) and a UL. The NTN device 104 may communicate with the network device 106 via a feeder link 108. In some cases, the feeder link 108 may be serviced by a ground satellite station, which may be connected to the network device 106. The network device 106 may be connected to and support multiple CNs (e.g., the first CN 126a, the second CN 126b and the third CN 126c). Each of the multiple CNs may be associated with a specific location (e.g., geographical territory and/or airspace), for example, a specific country. That is, for example, the first CN 126a may be a CN for support of a first country 110a, the second CN 126b may be a CN for support of a second country 110b, and the third CN 126c may be a CN for a third country 110c.

In the 3GPP NR and NG-RAN based NTN, an NTN cell may be capable of wider radio bean coverage. That is, for example, the coverage area of an NTN cell/beam may typically be much larger than a cell in a terrestrial network. In some instances, the wide beam coverage area 114 of the NTN cell 116 spans across multiple countries, such as the first country 110a, the second country 110b and the third country 110c, for example as illustrated in FIG. 1. The NTN may be configured to broadcast multiple public land mobile network (PLMN) identifiers and multiple tracking area codes (TACs) per PLMN (e.g., up to a total of 12 PLMN identifiers) in one NTN cell. In some cases, a UE 102 is not expected to perform a registration procedure if one of the currently broadcast TACs belongs to the UE's registration area.

In some cases, the UE 102 may report its coarse UE location information (e.g., coarse GNSS coordinates) to the NG-RAN. That is, the UE 102 may provide the coarse UE location information after access stratum (AS) security is established in the connected mode. Upon receiving information from the NTN device 104, the network device 106 may perform an access and mobility management function (AMF) selection based at least in part on the reported coarse UE information. That is, for example, the network device 106 may select the first CN 126a and its associated first AMF based at least in part on the coarse UE location information indicating the UE 102 likely to be located in the first country 110a. In some cases, the first AMF can provide service-based network function support within the control plane of the first CN 126a to enable other authorized network functions to access their services. It is to be understood that, in some instances, the first AMF may support AMF selection functionality to select another AMF for relocation.

However, in some instances, coarse UE location information may be insufficient for various network functions. For example, being able to precisely locate UE 102 may be beneficial for NTN to support some services subject to national regulations or other operational constraints. Some non-limiting examples of such regulations and operational constraints include but are not limited to detailed regulatory requirements (e.g., accuracy, privacy, reliability, latency, etc.) for network-verified UE location for potential use cases/services (e.g., emergency call, lawful intercept, public warning, charging/billing, etc.), public warning systems, and data retention policies in cross-border scenarios and international regions.

Accordingly, to meet such regulatory and operations requirements, the 5G or NR and NG-RAN based NTN may need to enforce that the selected PLMN is allowed to operate in the country for which the UE 102 is located. As such, the network may need to verify the location of the UE 102 during mobility management and session management procedures, for example.

For example, the first CN 126a and its associated first location management function (LMF) may perform a network-initiated positioning or positioning verification procedure. That is, the first LMF may initiate a multi-RTT positioning procedure in accordance with some embodiments. Additionally or alternatively, the first LMF may initiate a DL-TDOA positioning procedure in accordance with some embodiments. It is to be understood that the multi-RTT positioning procedure and the DL-TDOA positioning procedure are not considered or part of a hybrid positioning scheme, but rather individual positioning procedures or methods employed by the first LMF in accordance with some embodiments.

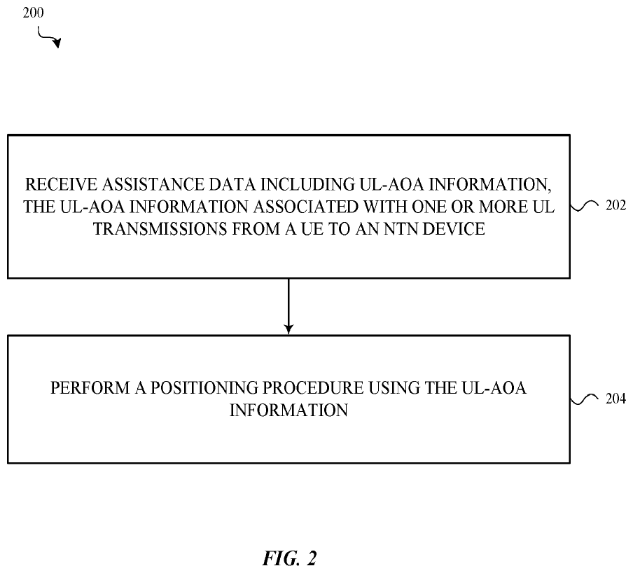

FIG. 2. illustrates an example method 200 of communication by an LMF (e.g., a device or a CN device), in accordance with some embodiments and various aspects of the present disclosure. The method 200 may be performed by a LMF (e.g., the first LMF) described with reference to FIG. 1, or by other LMFs and/or CN devices described herein. The method 200 may be performed using a processor, an interface or other components of the LMF.

At 202, the method 200 may include receiving assistance data including UL-AoA information, the UL-AoA information associated with one or more UL transmissions from a UE to an NTN device.

At 204, the method 200 may include performing a positioning procedure using the UL-AoA information.

In some embodiments of the method 200, for example, the assistance data may be received from the NTN device via a network device (e.g., gNB). That is, for example, the NTN device may measure one or more UL AoAs from the UE and report information and measurement results associated with the one or more UL AoAs to the network device, which may then report the assistance data to the LMF.

In some embodiments of the method 200, for example, the assistance data may further include at least one of satellite ephemeris information or UE reported TA information.

In some embodiments of the method 200, for example, the positioning procedure may be a multi-RTT positioning procedure. That is, for example, the UL-AoA information may be provided to the LMF as part of a multi-RTT positioning procedure in an NTN different from a positioning procedure using hybrid positioning.

In some embodiments of the method 200, for example, the assistance data may further include a timing information of transmitting a PRS or receiving an SRS at the NTN device. That is, for example, assistance data information received by the LMF in a transfer from the NTN device may be a timing information of transmitting a PRS or receiving an SRS at a satellite or a gNB.

In some embodiments of the method 200, for example, the LMF may be configured to receive, from the NTN device, measurement results including one or more UL-AoA measurement results. In some embodiments, the one or more UL-AoA measurement results may be associated with the one or more UL transmissions from the UE to the NTN device.

In some embodiments of the method 200, for example, the one or more UL-AoA measurement results may be received based at least in part on the NTN device being involved in the multi-RTT positioning procedure.

In some embodiments of the method 200, the received measurement results may further include a timing information of transmitting a PRS or receiving an SRS at the NTN device measurement results. That is, for example, measurement results received by the LMF in a transfer from the NTN device may be a timing information of transmitting a PRS or receiving an SRS at a satellite or a gNB measurement results.

In some embodiments of the method 200, for example, the multi-RTT positioning procedure is based at least in NR signals.

In some embodiments of the method 200, for example, the positioning procedure may be a DL-TDOA positioning procedure.

In some embodiments of the method 200, for example, the assistance data may further include a timing information of transmitting a PRS.

In some embodiments of the method 200, for example, the positioning procedure does not involve hybrid positioning. That is, for example, the positioning procedure involved in the NR based NTN is different from a positioning procedure that used hybrid positioning in accordance with some embodiments.

In some embodiments of the method 200, the positioning procedure may be an LMF-initiated positioning procedure. That is, for example, a network-initiated UE location verification procedure in accordance with some embodiments.

In some embodiments of the method 200, for example, the UL-AoA information may include positioning information of the NTN device corresponding to the one or more UL transmissions.

In some embodiments of the method 200, for example, the positioning information of the NTN device is received in a format based at least in part on a global coordinate system. That is, for example, the global coordinate system may be provided with or as part of the UL AoA information. In some embodiments, the global coordinate system may be based at least in part from the center of the earth. In some embodiments, the global coordinate system may be based at least in part from the center of the sun.

In some embodiments of the method 200, for example, the positioning information of the NTN device may be received in a format based at least in part on a local coordinate system.

In some embodiments of the method 200, for example, first positioning information of the NTN device corresponding to a first UL transmission of the one or more UL transmissions may be received in a format based at least in part on a local coordinate system. In some embodiments, second positioning information of the NTN device corresponding to a second UL transmission of the one or more UL transmissions may be received in a format relative to the first positioning information.

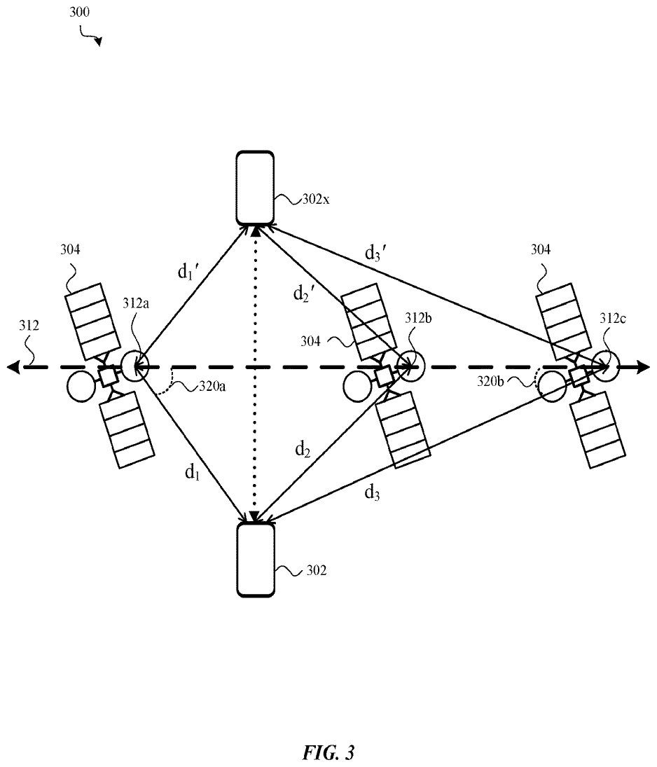

Turning now to FIG. 3, embodiments of method 200 and related aspects are further described. FIG. 3 illustrates an example scenario 300 in a 3GPP NR and NG-RAN based NTN, in accordance with some embodiments and various aspects of the present disclosure. The scenario 300 provides examples related to the enhancements of positioning procedures (e.g., a multi-RTT positioning procedure or a DL-TDOA positioning procedure) for supporting a network-verified UE location in NTN assuming a single satellite in view.

That is, the scenario 300 depicts an example of a mirror-image ambiguity issue that may occur in a 3GPP NR and NG-RAN based NTN. Techniques involving UL-AoA information and measurement results and other aspects are described with respect to the scenario 300.

An NTN device 304 may have an orbit 312 that is generally in a straight line and thus triangulation with respect to the UE 302 location is not feasible. As such, a mirror-image ambiguity with respect to NTN satellite 5G positioning techniques can occur when the same satellite positions and signals are observed in multiple places at the same time. That is, this mirror-image ambiguity may make it difficult to accurately identify a specific location, thereby leading to errors in positional determination. For example, the NTN device 304 may not be able to resolve the actual location of the UE 302 from a different UE 302x positioned in a mirror image with respect to the orbit 312 of the NTN device 304.

In a positioning procedure illustrated with respect to scenario 300 of FIG. 3 that includes the mirror-image ambiguity issue, a first RTT or DL-TDOA measurement may correspond the d1 distance measurement between the UE 302 and the NTN device 304, a second RTT or DL-TDOA measurement may correspond to the d2 measurement between the UE 302 and the NTN device 304, and a third RTT or DL-TDOA measurement may correspond to the d3 measurement between the UE 302 and the NTN device 304.

The first RTT or DL-TDOA measurement may occur at a first time 312a or point along the orbit 312. The second RTT or DL-TDOA measurement may occur at a second time 312b or point along the orbit 312. And the third RTT or DL-TDOA measurement may occur at a third time 312c or point along the orbit 312. However, absent certain assistance data and/or measurement results, the distance measurement d1 is indistinguishable from the distance measurement d1′ from the different UE 302x. Similarly, the distance measurement d2 is indistinguishable from the distance measurement d2′, and the distance measurement d3 is indistinguishable from the distance measurement d3′.

To address the mirror-image ambiguity issue, to distinguish between the UE 302 and the different UE 302x, various positioning procedure enhancements may be performed as described herein. For example, the NTN device 304 may obtain information and/or measurement results corresponding to UL-AoA(s) associated with one or more UL transmissions from the UE 302. That is, for example, the NTN device 304 may obtain information and/or measurement results corresponding to a first UL-AoA 320a associated with a first UL transmission from the UE 302. Additionally, the NTN device 304 may obtain information and/or measurement results corresponding to a second UL-AoA 320b associated with a second UL transmissions from the UE 302.

The first UL-AoA 320a may be associated with the distance measurement d1 between the UE 302 and the NTN device 304 at the first time 312a or point. The second UL-AoA 320b may be associated with the distance measurement d3 between the UE 302 and the NTN device 304 at the third time 312c or point.

It is to be appreciated that unlike a terrestrial network where a base station or gNB is fixed, in NTN, the NTN device 304 not only moves along the orbit 312, but also rotates. In some cases, the NTN device 304 may use the sun as primary reference for orienting itself throughout the orbit 312. In some instances, the NTN device 304 may enter an eclipse, and the reference point may be lost. In such instances, the NTN device 304 may be unable to accurately determine its positioning information to perform an UL-AoA measurement, for example, at the second time 312b or point along the orbit 312.

The NTN device 304 may begin to slew and initiate a yawing movement as the NTN device 304 searches for the sun (or another reference point). At that time, the NTN device 304 may be capable of determining positioning information, which is helpful when performing UL-AoA measurements.

That is, the positioning information of the NTN device 304 may be useful UL-AoA information for the LMF to have in performing the network or LMF-initiated positioning procedure. For example, UL-AoA information may include positioning information of the NTN device 304 corresponding to the first RTT or DL-TDOA measurement at the first time 312a or point along the orbit 312, when the first UL-AoA 320a is measured.

Similarly, the UL-AoA information may include positioning information of the NTN device 304 corresponding to the third RTT or DL-TDOA measurement at the third time 312c or point along the orbit 312, when the second UL-AoA 320b is measured. The UL transmissions that may be used when measuring the first UL-AoA 320a and the second UL-AoA 320b include but are not limited to SRS, physical random access channel (PRACH), PUCCH, and/or physical uplink shared channel (PUSCH). Additionally, in some cases, the techniques involving the UL-AoA operations may provide coarse UE location information, for example, enough to distinguish the UE 302 from the different UE 302x. That is, the positioning procedures (e.g., the multi-RTT positioning procedure or UL-TDOA positioning procedures) thereafter or in conjunction with UL-AoA operations may provide finer granularity information for the UE location.

In some cases, the NTN device 304 may report the positioning information based at least in part on a global coordinate system. In some cases, the global coordinate system may be based on the earth center or sun center. Additionally, the NTN device 304 may need to convert its local coordinate system to the global coordinate system. However, in some cases, the NTN device 304 may report the positioning information based at least in part on a local coordinate system.

In some cases, the NTN device 304 may report the reference coordinate system or reference coordination technique used for each of the first UL-AoA 320a and the second UL-AoA 320b as well as other UL AoA measurements. The NTN device 304 may also report the local coordinate system for these UL AoA measurements.

In some cases, the NTN device 304 may report the reference coordinate system related to the global coordinate system at a time of an UL AoA measurement. In some cases, the NTN device 304 may report the reference coordinate system or reference coordination technique related to the previous reported reference coordinate system at a time of an UL AoA measurement. That is, for example, the NTN device 304 may report first positioning information of the NTN device 304 at the first UL-AoA 320a (e.g., 30 degrees with respect to the global coordinate system). Then the NTN device 304 may report second positioning information of the NTN device 304 at the second UL-AoA 320b in a form relative to the first positioning information (e.g., a 10 degree rotation from the previous, first positioning information reported). Other positioning information techniques and reporting thereof are contemplated as would be understood given the benefit of the present disclosure.

With respect to multi-RTT positioning procedures, the NTN device 304 may transfer assistance data to the LMF. For example, the assistance data may include information as listed in 3GPP TS 38.305 version 17.3.0 (Release 17) § 8.10.2.3, Table 8.10.2.3-1. However, the NTN device 304 may additionally provide UL-AoA information, satellite ephemeris information, timing information of transmitting PRS or receiving sounding SRS at satellite or gNB, and/or UE reported TA information. Additionally, with respect to multi-RTT positioning procedures, the NTN device 304 may transfer measurement results to the LMF. For example, the measurement results may include measurement results as listed in 3GPP TS 38.305 version 17.3.0 (Release 17) § 8.10.2.3, Table 8.10.2.3-3. However, the NTN device 304 may additionally provide multiple UL-AoA measurement results (e.g., including azimuth and/or elevation), for example, when multi-RTT positioning procedures are performed in part by the NTN device 304 absent any hybrid positioning. That is, for example the multiple UL-AoA measurement results may be provided for NTN network-based UE location verification procedures. The NTN device 304 may additionally provide timing information of transmitting PRS or receiving SRS at satellite or gNB measurement results.

With respect to DL-TDOA positioning procedures, the NTN device 304 may transfer assistance data to the LMF. For example, the assistance data may include information as listed in 3GPP TS 38.305 version 17.3.0 (Release 17) § 8.12.2.3, Table 8.12.2.3-1. However, the NTN device 304 may additionally provide UL-AoA information, satellite ephemeris information, timing of transmitting PRS information at satellite or gNB, and/or UE reported TA information.

It is to be understood that other positioning procedures and techniques for UL-AoA information and measurement results may be used as would be apparent given the benefit of the present disclosure.

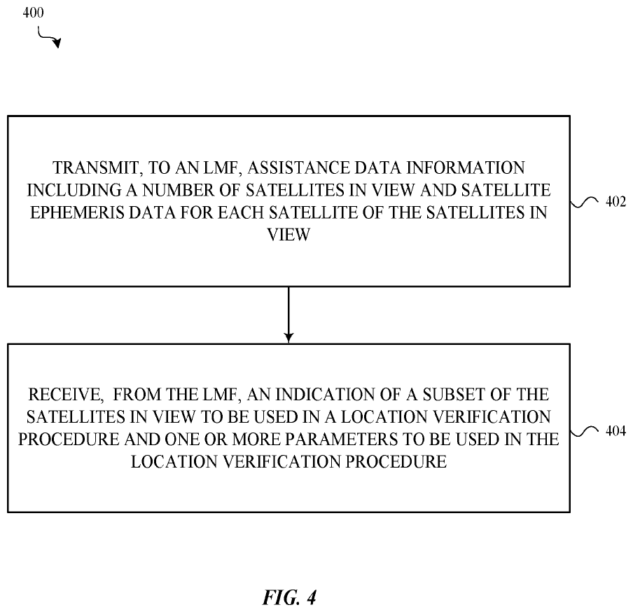

FIG. 4 illustrates an example method 400 of wireless communication by a UE, in accordance with some embodiments and various aspects of the present disclosure. The method 400 may be performed by the UE 102 described with reference to FIG. 1 or by other UEs described herein. The method 400 may be performed using a processor, a set of transceivers (e.g., one or more transceivers) or other components of a UE.

At 402, the method 400 may include transmitting, to an LMF, assistance data information including a number of satellites in view and satellite ephemeris data for one or more satellite of the satellites in view.

At 404, the method 400 may include receiving, from the LMF, an indication of a subset of the satellites in view to be used in a location verification procedure and one or more parameters to be used in the location verification procedure. In some embodiments, the indication may be received responsive to the transmitted assistance data information.

In some embodiments of the method 400, for example, the assistance data information may further include information corresponding to whether the satellites in view are of a same orbit.

In some embodiments of the method 400, for example, the assistance data information may further include information corresponding to whether the UE is in an orbit region of one or more satellites of the satellites in view.

In some embodiments of the method 400, for example, the UE may be configured to receive, from the LMF, a request to perform the location verification procedure. In some embodiments, the location verification procedure may be based at least in part on the subset of the satellites in view. In some embodiments, the location verification procedure may be a multi-RTT positioning procedure or a DL-TDOA positioning procedure.

Techniques related to network verification of UE location in the case of multiple NTN devices (e.g., satellites) being in view of a UE are described herein. In some cases, the UE may have multiple satellites in view. When multiple satellites are in view of the UE, UE location verification may be faster and more reliable, for example, by having multiple satellites participating in the positioning procedure. In some cases, the UE may report to LMF (e.g., through an NTN device or an NTN device and a network device) assistance information, such as but not limited to, number of satellites in view, ephemeris information of each satellite (or at least some satellites) in view, whether the multiple satellites are of the same orbit, and/or whether the UE is in the satellite orbit region of certain satellites.

In some cases, the UE may report to the LMF that two NTN devices are in view (e.g., a first satellite/gNB and a second satellite/gNB). The LMF may then coordinate a positioning procedure (e.g., a multi-RTT procedure) such that transmissions and receptions from both the first satellite/gNB and the second satellite/gNB are used in the positioning procedure. Thus, a delay associated with network verification of the UE location may be reduced by this coordinated approach. In some cases, the UE may report to the LMF that two NTN devices (e.g., a first satellite/gNB and a second satellite/gNB) are in the same orbit. In such cases, the LMF may coordinate a positioning procedure in which UL-AoA information and measurement reports are used similar to the single satellite in view scenarios. In some cases, the UE may report to the LMF that two NTN devices (e.g., a first satellite/gNB and a second satellite/gNB) are not it the same orbit. That is, for example, the first satellite/gNB may be heading on an orbit from south to north, and the second satellite/gNB may be heading on an orbit from west to east. In such cases, triangulation may be practical and the LMF may coordinate a positioning procedure absent any UL-AoA related operations.

In some cases, the UE may report to the LMF that the UE is in the orbit region of one or more NTN devices (e.g., a first satellite/gNB is in the orbit region of the UE, but a second satellite/gNB is not). In some examples, the orbit region may be considered the region directly below the NTN device along the orbit of the NTN devices. For example, if the UE is in the orbit region of first satellite/gNB the measurements may likely be inaccurate with respect to the first satellite/gNB. Additionally, if the UE is in the orbit region of all of the NTN devices in view, then the LMF may determine not to trigger a network verifying UE location procedure in some cases.

After receiving the assistance information from the UE, the LMF may determine which NTN devices are to participate in the UE location verification procedure. Additionally, the LMF may determine the parameters used in the UE location verification procedure. The LMF may determine this based at least in part on UE-reported assistance information.

Additionally, the LMF may send a positioning procedure measurement request and associated parameters to one or more of the UEs, the participating NTN devices, and/or the participating network devices.

It is to be understood that other network verification of UE location may be used as would be apparent given the benefit of the present disclosure.

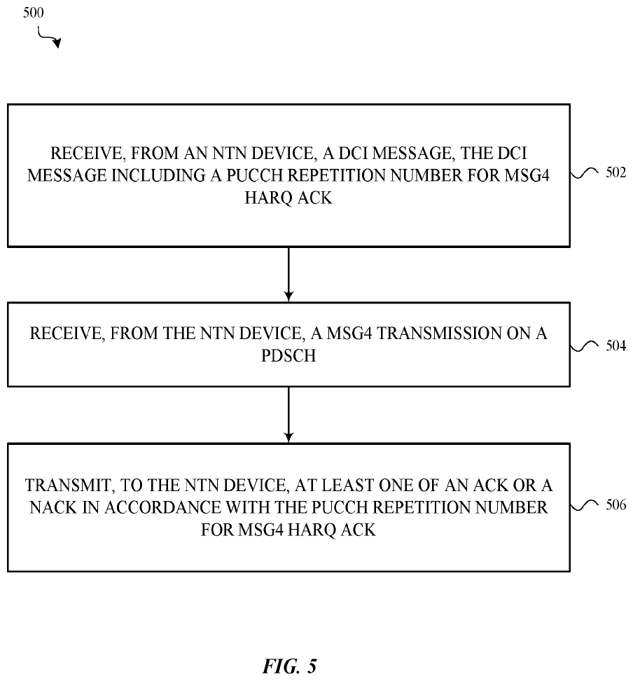

FIG. 5 illustrates an example method 500 of wireless communication by a UE, in accordance with some embodiments and various aspects of the present disclosure. The method 500 may be performed by the UE 102 described with reference to FIG. 1 or by other UEs described herein. The method 500 may be performed using a processor, a set of transceivers (e.g., one or more transceivers) or other components of a UE.

At 502, the method 500 may include receiving from an NTN device, a DCI message. In some embodiments, the DCI message may include a PUCCH repetition number for Msg4 HARQ ACK.

At 504, the method 500 may include receiving, from the NTN device, a Msg4 transmission on a physical downlink shared channel (PDSCH).

At 506, the method 500 may include transmitting to the NTN device, at least one of an ACK or a negative acknowledgement (NACK) in accordance with the PUCCH repetition number for Msg4 HARQ ACK.

In some embodiments of the method 500, for example, the PUCCH repetition number for Msg4 HARQ ACK may be a two-bit field in the DCI message based at least in part on operation in an NTN band. That is, for example, the inclusion of a bit field for PUCCH repetition number for Msg4 HARQ ACK is valid only when operating in an NTN band, in accordance with some embodiments.

In some embodiments of the method 500, for example, the UE may be configured to receive a number of configured Msg4 PUCCH repetition factors in a system information block (SIB) message. In some embodiments, the PUCCH repetition number for Msg4 HARQ ACK may include a field in the DCI message. In some embodiments, a bit width for the field of the PUCCH repetition number for Msg4 HARQ ACK in the DCI message may be based at least in part on the number of configured Msg4 PUCCH repetition factors in the SIB message.

In some embodiments of the method 500, for example, the DCI message may be absent a field indicating parameters for operation in a cell with shared spectrum (e.g., unlicensed spectrum).

In some embodiments of the method 500, for example, the PUCCH repetition number for Msg4 HARQ ACK may indicate a number of PUCCH repetitions to be transmitted by the UE responsive to the received Msg4 transmission.

In some embodiments of the method 500, for example, the DCI message may be a DCI format 1_0 with CRC scrambled by a TC-RNTI.

Techniques related to NR coverage enhancement to NTN for random access procedures are described herein. In NTN, the NTN device may be far from the UE and the pathloss may be large. Employing a PUCCH repetition for Msg4 HARQ ACK may benefit random access procedures in NTN.

In some cases, one or more repetition factors may be configured via a SIB message. In some cases, only one repetition factor may be configured via SIB. The value of the repetition factor may be one of {1, 2, 4, 8}, where a value of 1 indicates no repetitions. A UE capable of performing PUCCH repetition for Msg4 HARQ ACK may perform such repetition with any of the repetition factors configured via the SIB message.

Additionally, when multiple repetition factors (e.g., {1, 2, 4, 8} ) are configured via the SIB message, PUCCH repetition for Msg4 HARQ ACK may be dynamically determined and indicated by the NTN and/or gNB. In some cases, a new bit field may be introduced in DCI to indicate a dynamically selected number of PUCCH repetitions for Msg4 HARQ ACK. The bit field in the DCI message indicates a number of PUCCH repetitions that the UE should use for Msg4 HARQ ACK and may be designated as ‘Msg4 PUCCH repetition number’ in some examples.

In some cases, the bit field for the PUCCH repetition for Msg4 HARQ ACK in a DCI message is 2 bits. In some cases, the bit field has a bit width determined by a [log 2(N)] operation, where N is the number of Msg4 PUCCH repetition factors configured via the SIB message. In some cases, the PUCCH repetition for Msg4 HARQ ACK may be for operation in an NG-RAN based NTN band (e.g., NR band 255 or NR band 256). In some cases, if the DCI message is for operation in a band that is an NG-RAN based NTN band, the bit field exists or is not equal to 0. If the DCI message is for operation in a band that is not an NG-RAN based NTN band, the bit field is 0 and the PUCCH repetition for Msg4 HARQ ACK is not included.

When PUCCH repetition for Msg4 HARQ ACK is included in a DCI message, the NG-RAN based NTN band is a licensed band. For example, the bit field for the PUCCH repetition for Msg4 HARQ ACK may replace or be used instead of bit fields used for operation of a UE in a cell with shared spectrum such as an unlicensed band. That is, for example, a bit field for ‘ChannelAccess-CPext’ and a bit field for ‘Msg4 PUCCH repetition number’ may not simultaneously have 2 bits. That is, a total payload size of the DCI messages used may be limited in some examples.

By way of example, a UE may transmit a random access preamble (e.g., Msg1) to an NTN device. The NTN device may respond over a physical downlink control channel (PDCCH) with a DCI format 1_0 message with CRC scrambled by a random access radio network temporary identifier (RA-RNTI). The DCI format 1_0 message may schedule a random access response (RAR) Msg2 transmission, and the NTN device may transmit the RAR Msg2 to the UE. The UE may then transmit an Msg3 over a physical uplink shared channel (PUSCH) responsive to the RAR Msg2.

Next, the device may transmit another DCI format 1_0 message with CRC scrambled by the TC-RNTI over the PDCCH. This DCI format 1_0 message may include a two bit field for ‘Msg4 PUCCH repetition number’. The two bit field for ‘Msg4 PUCCH repetition number’ may indicate “11” instructing the UE to include eight PUCCH repetitions for Msg4 HARQ ACK. This DCI format 1_0 message may schedule a Msg4 (e.g., a contention resolution medium access control (MAC) control element (CE) (MAC CE)) over the PDSCH. The UE may receive the Msg4 and may respond with eight repetitions of HARQ ACK over the PUCCH. For example, eight ACKs if the Msg4 is successfully received or eight NACKs if the Msg4 is not successfully received.

It is to be understood that other examples of PUCCH repetition for Msg4 HARQ ACK are contemplated as would be understood given the benefit of the present disclosure.

Embodiments contemplated herein include complementary contexts of method 200, 400 or 500. For example, the complementary context of method 200 may be performed by an NTN device and may include transmitting, to an LMF, assistance data including UL-AoA information. The UL-AoA information may be associated with one or more UL transmissions that the NTN device received from a UE. The complementary context of method 200 may also include performing a positioning procedure using the UL-AoA information as instructed by the LMF. The complementary context of method 200 may also include transmitting, to the LMF, measurement results including one or more UL-AoA measurement results.

The complementary context of method 400 may be performed by an LMF and may include receiving, from a UE, assistance data information including a number of satellites in view of a UE and satellite ephemeris data for one or more satellites of the satellites in view; and transmitting to the UE an indication of a subset of the satellites in view to be used in a location verification procedure. The complementary context of method 400 may also include transmitting to one or both of the UE or an NTN device a request to perform the location verification procedure.

The complementary context of method 500 may be performed by an NTN device (and/or a network device such as a base station) and may include transmitting, to a UE, a DCI message, the DCI message comprising a PUCCH repetition number for Msg4 HARQ ACK; transmitting, to the UE, a Msg4 transmission on a PDSCH; and receiving, from the UE, at least one of an ACK or a NACK in accordance with the PUCCH repetition number for Msg4 HARQ ACK. The complementary context of method 400 may also include transmitting a number of configured Msg4 PUCCH repetition factors in a SIB message.

Embodiments contemplated herein include an apparatus having means to perform one or more elements of the method 200, 400 or 500. In the context of method 200, the apparatus may be, for example, an apparatus of an LMF (such as one or more network elements 626 of a CN 624 that is an LMF, as described herein). In the context of method 400 or 500, the apparatus may be, for example, an apparatus of a UE (such as a wireless device 702 that is a UE, as described herein). As would be apparent given the benefit of the disclosure and embodiments described herein, in the complementary context of method 200, the apparatus may be, for example, an apparatus of an NTN device and/or a network device (such as a NTN device 740 that can be a satellite and/or a network device 720 that can be a network device of a RAN, as described herein).

As would be apparent given the benefit of the disclosure and embodiments described herein, in the complementary context of method 400, the apparatus may be, for example, an apparatus of an LMF (such as one or more network elements 626 of a CN 624 that is an LMF, as described herein). As would be apparent given the benefit of the disclosure and embodiments described herein, in the complementary context of method 500, the apparatus may be, for example, an apparatus of an NTN device and/or a network device (such as a NTN device 740 that can be a satellite and/or a network device 720 that can be a network device of a RAN, as described herein).

Embodiments contemplated herein include one or more non-transitory computer-readable media storing instructions to cause an electronic device, upon execution of the instructions by one or more processors of the electronic device, to perform one or more elements of the method 200, 400 or 500. In the context of method 200, 400 or 500, the non-transitory computer-readable media may be, for example, a memory of a UE (such as a memory 706 of a wireless device 702 that is a UE, as described herein); a memory of an NTN device and/or a network device (such as a memory of a NTN device 740 that can be a satellite and/or a memory 724 of a network device 720 that can be a network device of a RAN, as described herein); or a memory of an LMF (such as a memory of one or more network elements 626 of a CN 624 that is an LMF, as described herein).

As would be apparent given the benefit of the disclosure and embodiments described herein, in the complementary context of method 200, 400 or 500, the non-transitory computer-readable media may be, for example, a memory of a UE (such as a memory 706 of a wireless device 702 that is a UE, as described herein); a memory of an NTN device and/or a network device (such as a memory of a NTN device 740 that can be a satellite and/or a memory 724 of a network device 720 that can be a network device of a RAN, as described herein); or a memory of an LMF (such as a memory of one or more network elements 626 of a CN 624 that is an LMF, as described herein).

Embodiments contemplated herein include an apparatus having logic, modules, or circuitry to perform one or more elements of the method 200, 400 or 500. In the context of method 200, 400 or 500, the apparatus may be, for example, an apparatus of a UE (such as a wireless device 702 that is a UE, as described herein); an apparatus of an NTN device and/or a network device (such as a NTN device 740 that can be a satellite and/or a network device 720 that can be a network device of a RAN, as described herein); or an apparatus of an LMF (such as one or more network elements 626 of a CN 624 that is an LMF, as described herein).

As would be apparent given the benefit of the disclosure and embodiments described herein, in the complementary context of method 200, 400 or 500, the apparatus may be, for example, an apparatus of a UE (such as a wireless device 702 that is a UE, as described herein); an apparatus of an NTN device and/or a network device (such as a NTN device 740 that can be a satellite and/or a network device 720 that can be a network device of a RAN, as described herein); or an apparatus of an LMF (such as one or more network elements 626 of a CN 624 that is an LMF, as described herein).

Embodiments contemplated herein include an apparatus having one or more processors and one or more computer-readable media, using or storing instructions that, when executed by the one or more processors, cause the one or more processors to perform one or more elements of the method 200, 400 or 500. In the context of method 200, 400 or 500, the apparatus may be, for example, an apparatus of a UE (such as a wireless device 702 that is a UE, as described herein); an apparatus of an NTN device and/or a network device (such as an NTN device 740 that can be a satellite and/or a network device 720 that can be a network device of a RAN, as described herein); or an apparatus of an LMF (such as one or more network elements 626 of a CN 624 that is an LMF, as described herein).

As would be apparent given the benefit of the disclosure and embodiments described herein, in the complementary context of method 200, 400 or 500, the apparatus may be, for example, an apparatus of a UE (such as a wireless device 702 that is a UE, as described herein); an apparatus of an NTN device and/or a network device (such as a NTN device 740 that can be a satellite and/or a network device 720 that can be a network device of a RAN, as described herein); or an apparatus of an LMF (such as one or more network elements 626 of a CN 624 that is an LMF, as described herein).

Embodiments contemplated herein include a signal as described in or related to one or more elements of the method 200, 400 or 500.

Embodiments contemplated herein include a computer program or computer program product having instructions, wherein execution of the program by a processor causes the processor to carry out one or more elements of the methods 200, 400 or 500. In the context of method 200, 400 or 500, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein); the processor may be a processor of an NTN device or a network device (such as a processor(s) of an NTN device 740 that can be a satellite and/or a processor(s) 722 of a network device 720 that can be a network device of a RAN, as described herein), and the instructions may be, for example, located in the processor and/or on a memory of the network device (such as a memory of an NTN device 740 that can be a satellite and/or a memory 724 of a network device 720 that can be a network device of a RAN, as described herein); or the processor may be a processor of an LMF (such as a processor(s) of one or more network elements 626 of a CN 624 that is an LMF, as described herein), and the instructions may be, for example, located in the processor and/or on a memory of the LMF (such as a memory of one or more network elements 626 of a CN 624 that is an LMF, as described herein).

As would be apparent given the benefit of the disclosure and embodiments described herein, in the complementary context of method 200, 400 or 500, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein); the processor may be a processor of an NTN device or a network device (such as a processor(s) of an NTN device 740 that can be a satellite and/or a processor(s) 722 of a network device 720 that can be a network device of a RAN, as described herein), and the instructions may be, for example, located in the processor and/or on a memory of the network device (such as a memory of an NTN device 740 that can be a satellite and/or a memory 724 of a network device 720 that can be a network device of a RAN, as described herein); or the processor may be a processor of an LMF (such as a processor(s) of one or more network elements 626 of a CN 624 that is an LMF, as described herein), and the instructions may be, for example, located in the processor and/or on a memory of the LMF (such as a memory of one or more network elements 626 of a CN 624 that is an LMF, as described herein).

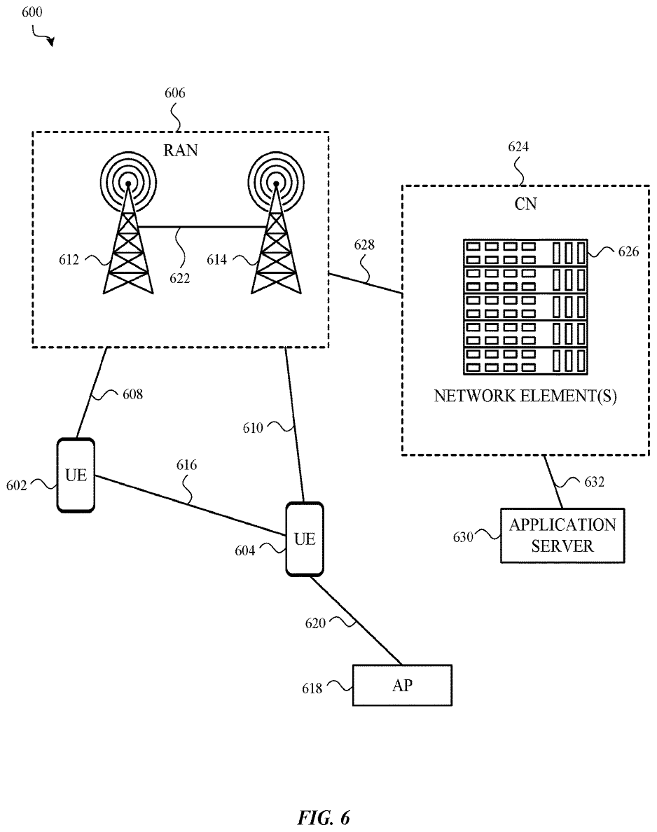

FIG. 6 illustrates an example architecture of a wireless communication system 600, according to embodiments disclosed herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also include any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which includes a physical communications interface. The RAN 606 can include one or more network devices, such as network device 612 and network device 614, that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can include a local wireless connection, such as a connection consistent with any IEEE 802.11 protocol, wherein the AP 618 may include a Wi-Fi® router. In this example, the AP 618 may be connected to another network (for example, the Internet) without going through a CN 624.

In embodiments, the UE 602 and UE 604 can be configured to communicate using OFDM communication signals with each other or with the network device 612 and/or the network device 614 over a multicarrier communication channel in accordance with various communication techniques, such as, but not limited to, an orthogonal frequency division multiple access (OFDMA) communication technique (e.g., for DL communications) or a single carrier frequency division multiple access (SC-FDMA) communication technique (e.g., for UL and ProSe or sidelink communications), although the scope of the embodiments is not limited in this respect. The OFDM signals can include a plurality of orthogonal subcarriers.

In some embodiments, all or parts of the network device 612 or network device 614 may be implemented as one or more software entities running on server computers as part of a virtual network. In addition, or in other embodiments, the network device 612 or network device 614 may be configured to communicate with one another via interface 622. In embodiments where the wireless communication system 600 is an LTE system (e.g., when the CN 624 is an EPC), the interface 622 may be an X2 interface.

The X2 interface may be defined between two or more network devices (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more network devices (e.g., two or more gNBs and the like) that connect to 5GC, between a network device 612 (e.g., a gNB) connecting to 5GC and an eNB, and/or between two eNBs connecting to 5GC (e.g., CN 624).

The RAN 606 is shown to be communicatively coupled to the CN 624. The CN 624 may include one or more network elements 626, which are configured to offer various data and telecommunications services to customers/subscribers (e.g., users of UE 602 and UE 604) who are connected to the CN 624 via the RAN 606. For example, the one or more network elements 626 may include an LMF. That is, the LMF may be a network entity defined in the 5G or NT CN to provide positioning functionality by means to determine a geographic position of the UE 602, the UE 604 and other wireless devices based at least in part on DL and UL radio signal measurement techniques. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an interface 628 (e.g., an SI interface). In embodiments, the SI interface may be split into two parts, an S1 user plane (S1-U) interface, which carries traffic data between the network device 612 or network device 614 and a serving gateway (S-GW), and the S1-MME interface, which is a signaling interface between the network device 612 or network device 614 and mobility management entities (MMEs).

In embodiments, the CN 624 may be a 5GC, and the RAN 606 may be connected with the CN 624 via an interface 628 (e.g., an NG interface). In embodiments, the NG interface may be split into two parts, an NG user plane (NG-U) interface, which carries traffic data between the network device 612 or network device 614 and a user plane function (UPF), and the S1 control plane (NG-C) interface, which is a signaling interface between the network device 612 or network device 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

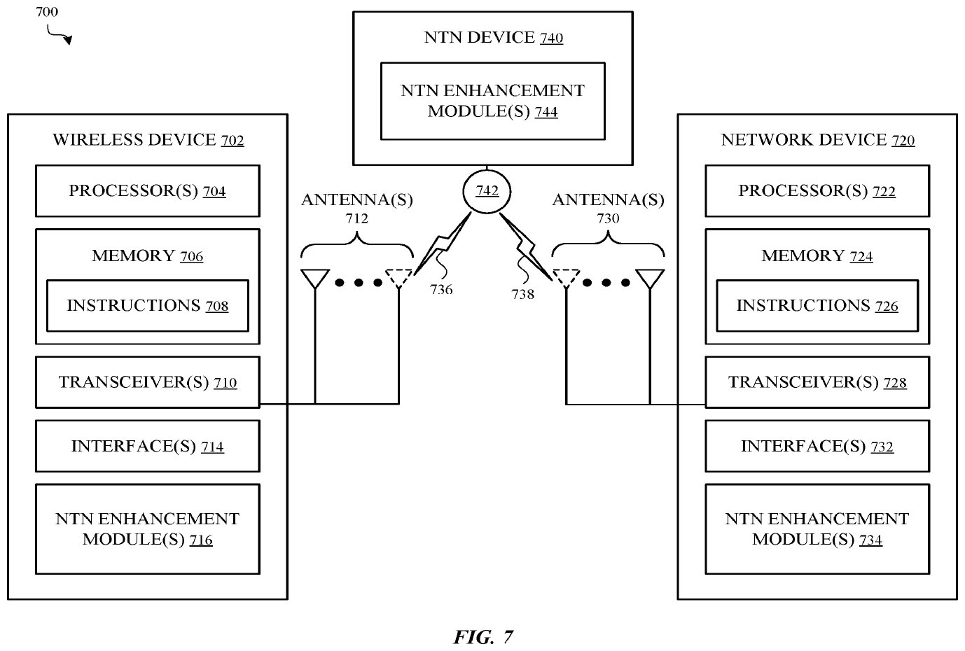

FIG. 7 illustrates a system 700 for performing signaling 736, 738 between a wireless device 702 and an NTN device 740 and/or a network device 720, and between the NTN device 740 and/or network device 720 and another network device 720, according to embodiments disclosed herein. The system 700 may be a portion of a wireless communication system as herein described. The wireless device 702 may be, for example, a UE of a wireless communication system. The network device 720 may be, for example, a network device (e.g., an eNB or a gNB) of a wireless communication system. The NTN device 740 may be, for example, an NTN device (e.g., a satellite, HIBS or HAPS) of a wireless and/or NTN communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 736) to and/or from the wireless device 702 with other devices (e.g., the NTN device 740) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include an NTN enhancement module(s) 716. The NTN enhancement module(s) 716 may be implemented via hardware, software, or combinations thereof. For example, the NTN enhancement module(s) 716 may be implemented as a processor, circuit, and/or instructions 708 stored in the memory 706 and executed by the processor(s) 704. In some examples, the NTN enhancement module(s) 716 may be integrated within the processor(s) 704 and/or the transceiver(s) 710. For example, the NTN enhancement module(s) 716 may be implemented by a combination of software components (e.g., executed by a DSP or a general processor) and hardware components (e.g., logic gates and circuitry) within the processor(s) 704 or the transceiver(s) 710.

The NTN enhancement module(s) 716 may be used for various aspects of the present disclosure, for example, aspects of FIGS. 1-5. The NTN enhancement module(s) 716 may be configured to, for example, apply or implement NTN enhancements including network-initiated UE location positioning and random access optimization techniques described herein.

The network device 720 may include one or more processor(s) 722. The processor(s) 722 may execute instructions such that various operations of the network device 720 are performed, as described herein. The processor(s) 722 may include one or more baseband processors implemented using, for example, a CPU, a DSP, an ASIC, a controller, an FPGA device, another hardware device, a firmware device, or any combination thereof configured to perform the operations described herein.

The network device 720 may include a memory 724. The memory 724 may be a non-transitory computer-readable storage medium that stores instructions 726 (which may include, for example, the instructions being executed by the processor(s) 722). The instructions 726 may also be referred to as program code or a computer program. The memory 724 may also store data used by, and results computed by, the processor(s) 722.

The network device 720 may include one or more transceiver(s) 728 that may include RF transmitter and/or receiver circuitry that use the antenna(s) 730 of the network device 720 to facilitate signaling (e.g., the signaling 738) to and/or from the network device 720 with other devices (e.g., the NTN device 740) according to corresponding RATs.

The network device 720 may include one or more antenna(s) 730 (e.g., one, two, four, or more). In embodiments having multiple antenna(s) 730, the network device 720 may perform MIMO, digital beamforming, analog beamforming, beam steering, etc., as has been described.

The network device 720 may include one or more interface(s) 732. The interface(s) 732 may be used to provide input to or output from the network device 720. For example, a network device 720 that is a network device may include interface(s) 732 made up of transmitters, receivers, and other circuitry (e.g., other than the transceiver(s) 728 and antenna(s) 730 already described) that enables the network device to communicate with other equipment in a core network, and/or that enables the network device to communicate with external networks, computers, databases, and the like for purposes of operations, administration, and maintenance of the network device or other equipment operably connected thereto.

The network device 720 may include an NTN enhancement module(s) 734. The NTN enhancement module(s) 734 may be implemented via hardware, software, or combinations thereof. For example, the NTN enhancement module(s) 734 may be implemented as a processor, circuit, and/or instructions 726 stored in the memory 724 and executed by the processor(s) 722. In some examples, the NTN enhancement module(s) 734 may be integrated within the processor(s) 722 and/or the transceiver(s) 728. For example, the NTN enhancement module(s) 734 may be implemented by a combination of software components (e.g., executed by a DSP or a general processor) and hardware components (e.g., logic gates and circuitry) within the processor(s) 722 or the transceiver(s) 728.

The NTN enhancement module(s) 734 may be used for various aspects of the present disclosure, for example, aspects of FIGS. 1-5. The NTN enhancement module(s) 734 may be configured to, for example, apply or implement NTN enhancements including network-initiated UE location positioning and random access optimization techniques described herein.

The NTN device 740 may include one or more processor(s). The processor(s) may execute instructions such that various operations of the NTN device 740 are performed, as described herein. The processor(s) may include one or more baseband processors implemented using, for example, a CPU, a DSP, an ASIC, a controller, an FPGA device, another hardware device, a firmware device, or any combination thereof configured to perform the operations described herein.

The NTN device 740 may include a memory. The memory may be a non-transitory computer-readable storage medium that stores instructions (which may include, for example, the instructions being executed by the processor(s)). The instructions may also be referred to as program code or a computer program. The memory may also store data used by, and results computed by, the processor(s).

The NTN device 740 may include one or more communication system(s) 742 that may include communication circuitry that use an antenna(s) or a dish(es) of the NTN device 740 to facilitate signaling (e.g., the signaling 736) to and/or from the NTN device 740 with other devices (e.g., the wireless device 702) and signaling (e.g., the signaling 738) to and/or from the NTN device 740 with other devices (e.g., the network device 720) according to corresponding RATs.

The NTN device 740 may include one or more interface(s). The interface(s) may be used to provide input to or output from the NTN device 740. For example, an NTN device 740 that is a satellite may include interface(s) made up of satellite communication circuitry that enables the satellite to communicate with other equipment in an NTN, and/or that enables the satellite to communicate with external networks, computers, databases, and the like for purposes of operations, administration, and maintenance of the network device or other equipment operably connected thereto.

The NTN device 740 may include an NTN enhancement module(s) 744. The NTN enhancement module(s) 744 may be implemented via hardware, software, or combinations thereof. For example, the NTN enhancement module(s) 744 may be implemented as a processor, circuit, and/or instructions stored in the memory and executed by the processor(s). In some examples, the NTN enhancement module(s) 744 may be integrated within the processor(s) and/or the one or more communication system(s) 742. For example, the NTN enhancement module(s) 744 may be implemented by a combination of software components (e.g., executed by a DSP or a general processor) and hardware components (e.g., logic gates and circuitry) within the processor(s) or the one or more communication system(s) 742.

The NTN enhancement module(s) 744 may be used for various aspects of the present disclosure, for example, aspects of FIGS. 1-5. The NTN enhancement module(s) 744 may be configured to, for example, apply or implement NTN enhancements including network-initiated UE location positioning and random access optimization techniques described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Additionally, the present disclosure recognizes that the use of location information data, in the present technology, can be used to the benefit of users. For example, the location information data can be used to authenticate a user to access their device. Further, other uses for location information data that benefit the user are also contemplated by the present disclosure. Moreover, the present disclosure contemplates that the entities responsible for the collection, analysis, disclosure, transfer, storage, or other use of such location information data will comply with well-established privacy policies and/or privacy practices. In particular, such entities should implement and consistently use privacy policies and practices that are generally recognized as meeting or exceeding industry or governmental requirements for maintaining location information data private and secure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A location management function (LMF), comprising:
an interface; and
a processor configured to,
receive, via the interface, assistance data including uplink (UL)-angle of arrival (AoA) information, the UL-AoA information associated with one or more UL transmissions from a user equipment (UE) to a non-terrestrial network (NTN) device; and
perform a positioning procedure using the UL-AoA information,
wherein the UL-AoA information comprises positioning information of the NTN device corresponding to the one or more UL transmissions.

2. The LMF of claim 1, wherein the assistance data further includes at least one of:
satellite ephemeris information; or
UE reported timing advance (TA) information.

3. The LMF of claim 1, wherein the positioning procedure is a multi-round trip time (multi-RTT) positioning procedure.

4. The LMF of claim 3, wherein the assistance data further includes a timing information of transmitting a positioning reference signal (PRS) or receiving a sounding reference signal (SRS) at the NTN device.

5. The LMF of claim 3, wherein the processor is configured to:
receive, via the interface and from the NTN device, measurement results including one or more UL-AoA measurement results, the one or more UL-AoA measurement results associated with the one or more UL transmissions from the UE to the NTN device.

6. The LMF of claim 5, wherein the one or more UL-AoA measurement results are received based at least in part on the NTN device being involved in the multi-RTT positioning procedure.

7. The LMF of claim 5, wherein the received measurement results further includes a timing information of transmitting a positioning reference signal (PRS) or receiving a sounding reference signal (SRS) at the NTN device measurement results.

8. The LMF of claim 1, wherein the positioning procedure is a downlink (DL)-time difference of arrival (TDOA) positioning procedure.

9. The LMF of claim 8, wherein the assistance data further includes a timing information of transmitting a positioning reference signal (PRS) at the NTN device.

10. The LMF of claim 1, wherein:
the positioning procedure does not involve hybrid positioning; and
the positioning procedure is an LMF-initiated positioning procedure.

11. (canceled)

12. The LMF of claim 1, wherein the positioning information of the NTN device is received in a format based at least in part on a global coordinate system.

13. The LMF of claim 1, wherein the positioning information of the NTN device is received in a format based at least in part on a local coordinate system.

14. The LMF of claim 1, wherein:
first positioning information of the NTN device corresponding to a first UL transmission of the one or more UL transmissions is received in a format based at least in part on a local coordinate system; and
second positioning information of the NTN device corresponding to a second UL transmission of the one or more UL transmissions is received in a format relative to the first positioning information.

15. An apparatus comprising memory coupled to a processor, the processor configured to:
generate for transmission to a location management function (LMF), assistance data information including a number of satellites in view and satellite ephemeris data for one or more satellites of the number of satellites in view; and
receive, from the LMF,
an indication of a subset of the number of satellites in view to be used in a location verification procedure, the indication received responsive to the transmitted assistance data information; and
one or more parameters to be used in the location verification procedure.

16. The apparatus of claim 15, wherein the assistance data information further includes information corresponding to whether the number of satellites in view are of a same orbit.

17. The apparatus of claim 15, wherein the processor is configured to:
receive, from the LMF, a request to perform the location verification procedure; wherein:
the location verification procedure is based at least in part on the subset of the number of satellites in view; and
the location verification procedure is a multi-round trip time (multi-RTT) positioning procedure or a downlink (DL)-time difference of arrival (TDOA) positioning procedure.

18. An apparatus comprising memory coupled to a processor, the processor configured to:
receive from a non-terrestrial network (NTN) device, a downlink control information (DCI) message, the DCI message comprising a physical uplink control channel (PUCCH) repetition number for Msg4 hybrid automatic repeat request (HARQ) acknowledgement (ACK);
receive from the NTN device, a Msg4 transmission on a physical downlink shared channel (PDSCH); and
generate for transmission to the NTN device, at least one of an ACK or a negative acknowledgement (NACK) in accordance with the PUCCH repetition number for Msg4 HARQ ACK.

19. The apparatus of claim 18, wherein the PUCCH repetition number for Msg4 HARQ ACK is a two-bit field in the DCI message based at least in part on operation in an NTN band.

20. The apparatus of claim 18, wherein the processor is configured to:
receive, a number of configured Msg4 PUCCH repetition factors in a system information block (SIB) message; wherein:
the PUCCH repetition number for Msg4 HARQ ACK comprises a field in the DCI message; and
a bit width for the field of the PUCCH repetition number for Msg4 HARQ ACK in the DCI message is based at least in part on the number of configured Msg4 PUCCH repetition factors in the SIB message.
